(19) United States
(12) Patent Application Publication
(10) Pub. No.: US 2015/0179111 A1
(43) Pub. Date: Jun. 25, 2015

(54) LIQUID CRYSTAL DISPLAY DEVICE AS WELL AS BACKLIGHT SOURCE AND DIMMING METHOD FOR THE SAME

(71) Applicant: SHENZHEN CHINA STAR OPTOELECTRONICS TECHNOLOGY CO. LTD., Shenzhen, Guangdong (CN)

(72) Inventor: Xinhong Chen, Shenzhen (CN)

(21) Appl. No.: 14/240,366

(22) PCT Filed: Jan. 17, 2014
(86) PCT No.: PCT/CN2014/070836

§ 371 Date: Feb. 22, 2014

(30) Foreign Application Priority Data
Dec. 25, 2013 (CN) 201310729048.1

(51) Int. Cl. G09G 3/34

(52) U.S. Cl. CPC G09G 3/3413; G09G 3/342; G09G 2320/0666; G09G 2340/06

(57) ABSTRACT

The present disclosure relates to a liquid crystal display device, a backlight source, and a dimming method for the liquid crystal display device. The backlight source for a liquid crystal display device comprises: a backlight lamp group which is divided into at least two areas, each being provided with a group of multi-color LED light sources distributed therein, and the individual areas formed by dividing the backlight lamp group being in one-to-one correspondence with individual display picture regions formed by dividing a liquid crystal display panel; a time sequence control circuit, which generates time sequence signals for individual LEDs of a group of multi-color LED light sources in the backlight lamp group area associated with a respective region; and an LED driving circuit, which controls the brightness of individual LEDs of the multi-color LED light sources in respective areas, so as to adjust the hue among the areas and the brightness of the current area. Therefore, through dividing the backlight source so as to be in correspondence with different display picture regions of the liquid crystal display panel, and controlling the brightness of the LEDs with various colors of the multi-color LED light sources in different areas based on the display contents in the different display picture regions, the hue among the areas can be changed, and the expression of LCD pictures can be improved.

### FIELD OF THE INVENTION

The present disclosure relates to liquid crystal display technologies, and particularly relates to a liquid crystal display device, a backlight source, and a dimming method for the liquid crystal display device.

### BACKGROUND OF THE INVENTION

In recent years, with the display trend of thinness, liquid crystal display (LCD) has been widely used in various electronic products, such as mobile phones, notebook computers and color televisions, etc.

LCD is a non-luminous display device, and is capable of achieving a display function only by virtue of a backlight source. The performance of the backlight source will directly influence the quality of image display of the LCD. Therefore, the backlight source can be considered as a key component in an LCD module. An LCD backlight source system is mainly composed of a light source, a light guide plate, an optical diaphragm, a plastic frame, and the like.

The LCD backlight sources already put into use and under development mainly include the types of CCFL (cold cathode fluorescent lamps), EL (electro luminescent), white-light LED (light-emitting diode), and the like. Compared with CCFL and EL backlight sources, white-light LED backlight sources have such advantages as high brightness, high color purity, long life, strong adaptability, good reliability, low cost, easy industrialization, and the like.

However, LCD with a white-light LED as a backlight source has the problem of a poor color gamut. Therefore, how to solve the above-mentioned problem so as to expand the range of color gamut of LCD is one of the tasks dedicated in the industry.

### SUMMARY OF THE INVENTION

One of the technical problems to be solved in the present disclosure is to provide a backlight source which is capable of expanding the range of color gamut of liquid crystal display. In addition, a liquid crystal display device and a dimming method for the same are further provided.

1) In order to solve the above-mentioned technical problems, the present disclosure provides a backlight source for a liquid crystal display device, comprising: a backlight lamp group which is divided into at least two areas, each being provided with a group of multi-color LED light sources distributed therein, and the individual areas formed by dividing the backlight lamp group being in one-to-one correspondence with individual display picture regions formed by dividing a liquid crystal display panel; a time sequence control circuit, which, based on the hue and brightness information of an image needing to be displayed currently in the image data analyzed by different display picture regions of the liquid crystal display panel, generates time sequence signals for individual LEDs of a group of multi-color LED light sources in the backlight lamp group area associated with a respective region; and an LED driving circuit, which is electrically connected between the time sequence control circuit and the backlight lamp group, and, based on the received time sequence signals for individual LEDs associated with different backlight lamp group areas respectively, controls the brightness of individual LEDs of the multi-color LED light sources in respective areas, so as to adjust the hue among the areas and the brightness of the current area.

2) In a preferred embodiment of item 1) of the present disclosure, when the backlight source is a side-light type backlight source, each multi-color LED light source includes a plurality of groups of LED lamp bars formed by providing red LEDs, green LEDs, blue LEDs and white LEDs distributed with a set sequence, wherein each of the white LEDs is used for performing brightness compensation on the area where it is located.

3) In a preferred embodiment of item 1) or 2) of the present disclosure, when the backlight source is a direct type backlight source, each multi-color LED light source includes at least one group of annular lamp bead units formed by providing red LEDs, green LEDs, blue LEDs and white LEDs distributed with a set sequence, wherein each white LEDs is used for performing brightness compensation on the area where it is located.

4) In a preferred embodiment of any one of items 1) to 3) of the present disclosure, the time sequence control circuit comprises: an image data obtaining device, used for obtaining image data of the liquid crystal display panel; an image data partition calculating device, used for processing the image data obtained by the image data obtaining device, and, based on the pixel position of each image data in the current region of the liquid crystal display panel, calculating the average hue and brightness information in the current region; and an LED time sequence signal generating module, used for, based on the average hue and brightness information in each region, generating time sequence signals for individual LEDs of a group of multi-color LED light sources in the backlight lamp group area associated with a respective region.

5) According to another aspect of the present disclosure, a liquid crystal display device is further provided, comprising: a liquid crystal display panel, which performs image display based on image data obtained, wherein the liquid crystal display panel is divided into a plurality of display picture regions; and a backlight source. Said backlight source comprises: a backlight lamp group which is divided into at least two areas, each being provided with a group of multi-color LED light sources distributed therein, and the individual areas formed by dividing the backlight lamp group being in one-to-one correspondence with individual display picture regions formed by dividing a liquid crystal display panel; a time sequence control circuit, which, based on the hue and brightness information of an image needing to be displayed currently in the image data analyzed by different display picture regions of the liquid crystal display panel, generates time sequence signals for individual LEDs of a group of multi-color LED light sources in the backlight lamp group area associated with a respective region; and an LED driving circuit, which is electrically connected between the time sequence control circuit and the backlight lamp group, and, based on the received time sequence signals for individual LEDs associated with different backlight lamp group areas respectively, controls the brightness of individual LEDs of the multi-color LED light sources in respective areas, so as to adjust the hue among the areas and the brightness of the current area.

6) In a preferred embodiment of item 5) of the present disclosure, the time sequence control circuit comprises: an image data obtaining device, used for obtaining image data of the liquid crystal display panel; an image data partition calculating device, used for processing the image data obtained by the image data obtaining device, and, based on the pixel position of each image data in the current region of the liquid crystal display panel, calculating the average hue and brightness information in the current region; and an LED time sequence signal generating module, used for, based on the average hue and brightness information in each region, generating time sequence signals for individual LEDs of a group of multi-color LED light sources in the backlight lamp group area associated with a respective region.

7) In a preferred embodiment of item 5) or 6) of the present disclosure, the multi-color LED light source is one formed by providing multi-color LEDs, including white LEDs, distributed with a set sequence, wherein each white LED is used for performing brightness compensation on the area where it is located; and the time sequence control circuit, based on the hue and brightness information of an image needing to be displayed currently in the image data analyzed by different display picture regions of the liquid crystal display panel, generates time sequence signals for individual LEDs other than white LEDS in each backlight lamp group area associated with a respective region, so as to perform hue matching on pictures in the corresponding areas, and generates time sequence signals of the white LEDs so as to perform brightness supplement.

8) In a preferred embodiment of any one of items 5) to 7) of the present disclosure, when the backlight source is a direct type backlight source, each multi-color LED light source includes at least one group of annular lamp bead units formed by distributing red LEDs, green LEDs, blue LEDs and white LEDs according to a set sequence, wherein each white LEDs is used for performing brightness compensation on the area where it is located.

9) According to a further aspect of the present disclosure, a dimming method for a liquid crystal display device is further provided, comprising: dividing a backlight lamp group of a backlight source into at least two areas, each being provided with multi-color LED light sources distributed therein, and the individual areas formed by dividing the backlight lamp group being in one-to-one correspondence with individual display picture regions formed by dividing a liquid crystal display panel; obtaining image data, through a time sequence control circuit, from the liquid crystal display panel, and, based on the hue and brightness information of an image needing to be displayed currently in the analyzed by different display picture regions of the liquid crystal display panel, generates time sequence signals for individual LEDs of a group of multi-color LED light sources in each backlight lamp group area associated with a respective region; and, based on the received time sequence signals for individual LEDs associated with different backlight lamp group areas respectively, controlling, through an LED driving circuit, the brightness of individual LEDs of the multi-color LED light sources in respective areas, so as to adjust the hue of the areas and the brightness of the current area.

10) In a preferred embodiment of item 9) of the present disclosure, the multi-color LED light source is one formed by providing multi-color LEDs, including white LEDs, distributed with a set sequence, wherein each white LED is used for performing brightness compensation on the area where it is located; and the time sequence control circuit, based on the hue and brightness information of an image needing to be displayed currently in the image data analyzed by different display picture regions of the liquid crystal display panel, generates time sequence signals for individual LEDs other than white LEDS in each backlight lamp group area associated with a respective region, so as to perform hue matching on pictures in the corresponding areas, and generates time sequence signals of the white LEDs so as to perform brightness supplement.

Compared with the prior art, one or more examples of the present disclosure may have the following advantages. In the backlight source structure of the present disclosure, through dividing the backlight source structure so as to be in correspondence with different display picture regions of the liquid crystal display panel, and controlling the brightness of the LEDs with various colors, such as red LEDs, green LEDs and blue LEDs, of the multi-color LED light sources in different areas based on the display contents in the different display picture regions, the hue among the areas can be changed, and the expression of LCD pictures can be improved. Therefore, the color can be brighter, and the color gamut range can be expanded. Meanwhile, with the brightness of an area in which a white LED in the multi-color LED light source is located being compensated by controlling said white LEDs, the contrast can be improved.

Other features and advantages of the present disclosure will be illustrated in the following description, and are partially obvious from the description or understood through implementing the present disclosure. The objectives and other advantages of the present disclosure may be realized and obtained through the structures specified in the description, claims and accompanying drawings.

### BRIEF DESCRIPTION OF THE DRAWINGS

The accompanying drawings are provided for further understanding the present disclosure, constitute a part of the description, and are used for interpreting the present disclosure together with the examples of the present disclosure, rather than limiting the present disclosure. In the accompanying drawings:

FIG. 1 schematically shows the distribution of multi-color LED light sources in a sidelight type backlight source according to an example of the present disclosure;

FIG. 2(A) and FIG. 2(B) schematically show the distribution of multi-color LED light sources in a direct type backlight source according to an example of the present disclosure;

FIG. 3 schematically shows the direct type backlight source formed by distributing LED lamp bead units as shown in FIG. 2(A) or FIG. 2(B);

FIG. 4 is a structural schematic diagram of a backlight source according to an example of the present disclosure;

FIG. 5 is an example diagram of a display content with a blue hue as a whole; and

FIG. 6(A), FIG. 6(B) and FIG. 6(C) are schematic diagrams of the driving time sequence signals for area A, area B and area C, respectively, as shown in FIG. 5.

### DETAILED DESCRIPTION OF THE EMBODIMENTS

To enable the objectives, technical solutions and advantages of the present disclosure clearer, the present disclosure is further illustrated in detail below in conjunction with the accompanying drawings.

In the example, the backlight source for a liquid crystal display comprises a backlight lamp group, which is divided into at least two areas, each being provided with a group of multi-color LED light sources distributed therein, and the individual areas formed by dividing the backlight lamp group being in one-to-one correspondence with individual display picture regions formed by dividing a liquid crystal display panel. The multi-color LED light source is one formed by providing a plurality of multi-color LEDs, including white LEDs, distributed with a set sequence, wherein each white LED is used for performing brightness compensation on the area where it is located. By virtue of the above-mentioned arrangements, the multi-color LED light source can be controlled independently for individual areas, so as to optimize the backlight source.

It should be noted that the brightness compensation for the white LEDs is the compensation for brightness and darkness. The brightness of the LEDs with other colors (such as red, green, and blue) depends on pictures, while the brightness of white LEDs much depends on the brightness setting of a user.

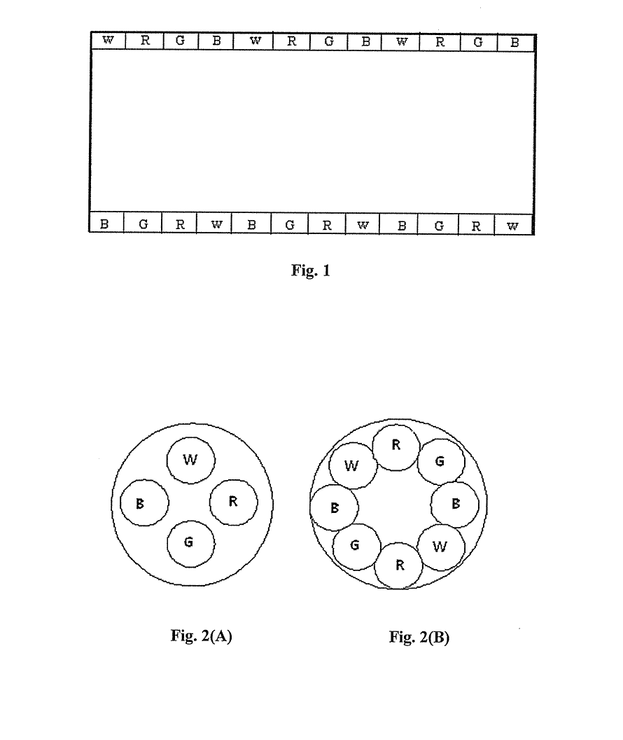

In order to facilitate the design of the backlight source, it is preferred to enable the quantities of the LEDs with various colors are equal to each other. FIG. 1 schematically shows the distribution of the white (W) LEDs, red (R) LEDs, green (G) LEDs and blue (B) LEDs in a side-light type backlight source according to the present disclosure. Two LED lamp bars are provided at the upper side and the lower side of the backlight source respectively, and the LED lamp bar at each side is formed by three groups of LEDs distributed according to a sequence of white LEDs, red LEDs, green LEDs and blue LEDs.

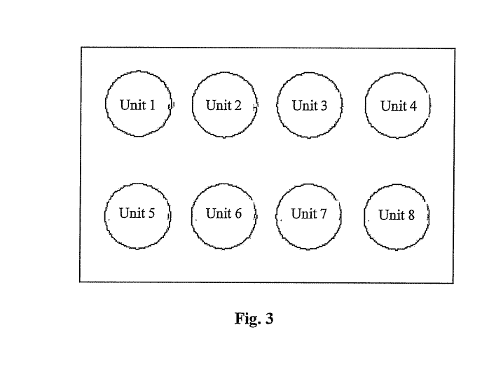

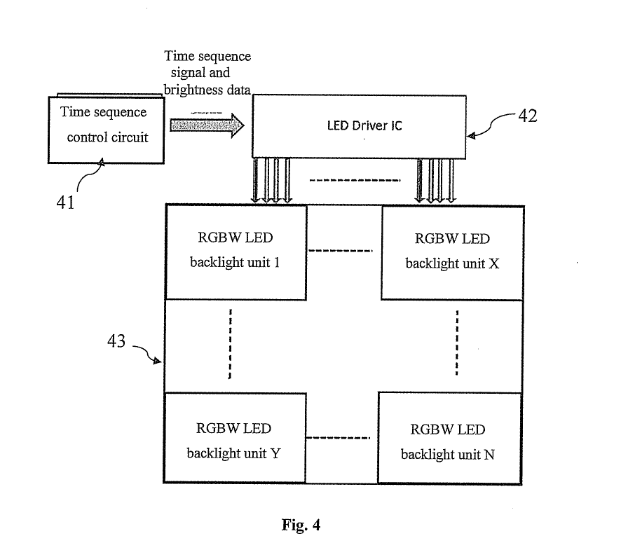

With regard to the case that the backlight source is a direct type backlight source, as shown in FIG. 2(A), the multi-color LED light source includes a group of annular lamp bead units formed by a plurality of LEDs distributed according to a clockwise sequence of white (W) LEDs, red (R) LEDs, green (G) LEDs and blue (B) LEDs. As shown in FIG. 2(B), the multi-color LED light source includes two groups of annular lamp bead units, each formed by a plurality of LEDs distributed according to a clockwise sequence of white LEDs, red LEDs, green LEDs and blue LEDs. Then, the annular lamp bead units arranged as above are distributed in different areas of the backlight source in a manner as shown in FIG. 3 (i.e., units 1 to 8 shown in the figure), so as to form the whole backlight source.

Of course, the above-mentioned sequence for arranging the LED lamp bars is merely provided as an example. Moreover, the quantities of the LEDs with various colors may be different from each other. Those skilled in the art can make suitable modifications thereon according to actual needs.

In addition, in the case that the backlight source is a side-light side backlight source, the backlight source further comprises a light guide plate, which is used for guiding the scattering directions of light emitted from the multi-color LED light sources.

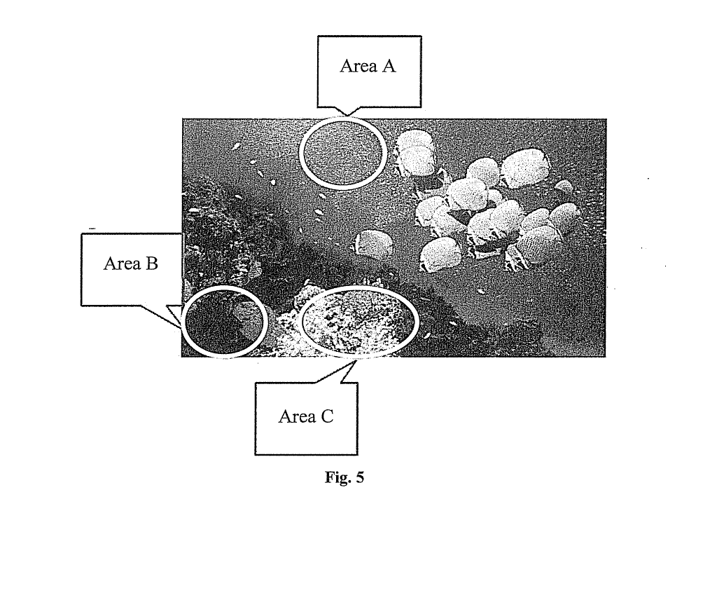

FIG. 4 is a structural schematic diagram of a backlight source according to an example of the present disclosure, which is provided in an illustrative manner. As shown in FIG. 4, the backlight source mainly comprises a time sequence control circuit 41, a LED backlight lamp group 43, and an LED driver IC (integrated circuit) 42 electrically connected with the time sequence control circuit 41 and the LED backlight lamp group 43.

Based on the hue and brightness information of an image that should be displayed at the current time point in the image data analyzed by different display picture regions of the liquid crystal display panel, the time sequence control circuit 41 can generate time sequence signals for individual LEDs of a group of multi-color LED light sources in the backlight lamp group area associated with a respective region.

The time sequence control circuit 41 further comprises an image data obtaining device, an image data partition calculating device, and an LED time sequence signal generating module. The image data obtaining device is used for obtaining the image data of the liquid crystal display panel. The image data partition calculating device is used for processing the image data obtained by the image data obtaining device, and, based on the pixel position of each image data in the current region of the liquid crystal display panel, calculating the average hue and brightness information in the current region. The LED time sequence signal generating module is used for generating, based on the average hue and brightness information in individual regions, time sequence signals for individual LEDs of a group of multi-color LED light sources in a backlight source area associated with a respective region.

Based on the time sequence signals for individual LEDs related to different backlight lamp group areas received from the time sequence control circuit 41, the LED driver IC 42 controls the brightness of individual LEDs, such as red LEDs, green LEDs, blue LEDs and white LEDs, of the multi-color LED light sources in the respective areas. The LED backlight group 43 comprises a plurality of preset areas, such as RGBW LED backlight unit 1 to RGBW LED backlight unit N as shown in FIG. 4, which are in one-to-one correspondence with the various display picture regions formed by dividing the liquid crystal display panel.

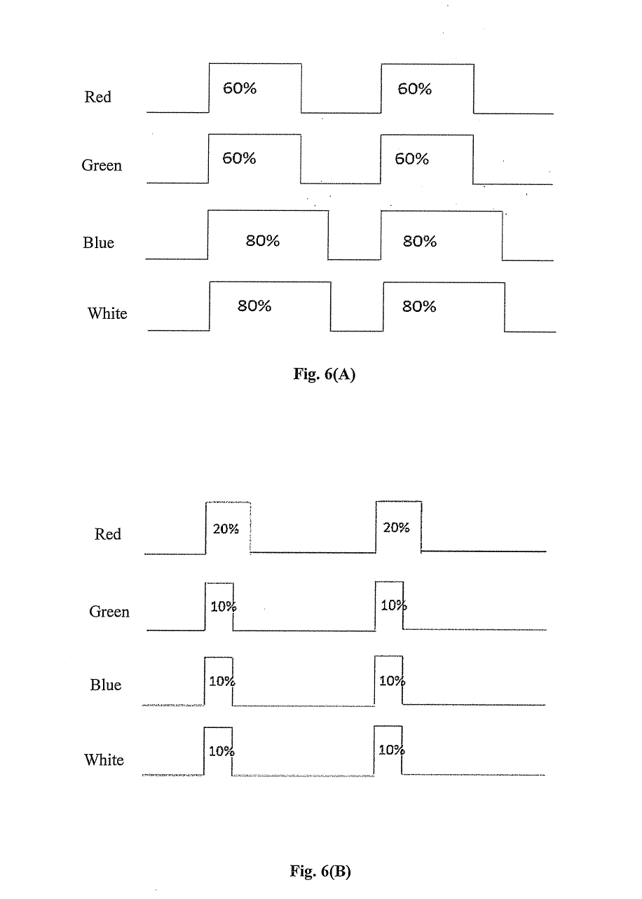

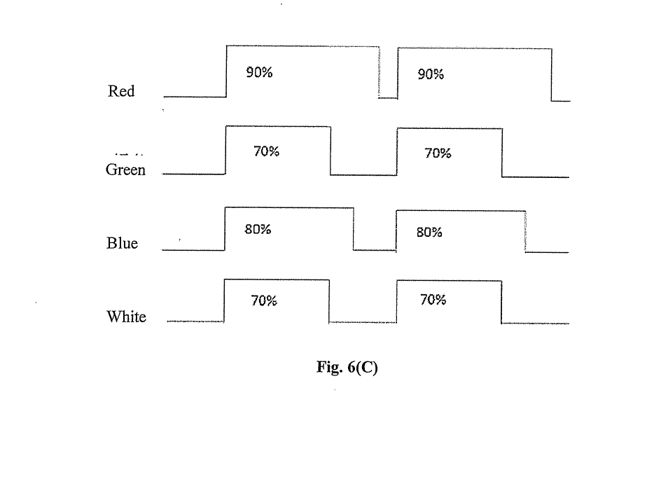

In order to further illustrate how to adjust the backlight source, reference is made to FIG. 5 and FIG. 6 in detail below.

FIG. 5 shows an example of a display content with a blue hue as a whole, wherein the effect to be displayed in area A is a high-brightness bluish hue, the effect to be displayed in area B is a low-brightness reddish hue, and the effect to be displayed in area C is a high-brightness reddish hue. Then, the time sequence control circuit 41 generates, based on the hue and brightness information of an image that should be displayed at the current time point in the image data analyzed by different display picture regions of the liquid crystal display panel, time sequence signals for LEDs other that white LEDs in the backlight lamp group area associated with a respective area, so as to perform hue matching on pictures in said respective area, and generates time sequence signals for the white LEDs so as to perform brightness compensation. In the sample, the time sequence signals of red LEDs, green LEDs, blue LEDs and white LEDs of the various multi-color LED light sources corresponding to the three areas are shown in FIG. 6(A), FIG. 6(B) and FIG. 6(C) respectively.

As shown in FIG. 6(A), because the display effect of the area A is a high-brightness bluish hue, the pulse duty factors of the LEDs with various colors are greater than 50%, and the pulse duty factor of blue LEDs is higher, 80%.

As shown in FIG. 6(B), as the display effect of area B is a low-brightness reddish hue, the pulse duty factors of the LEDs with various colors are less than 50%, and the pulse duty factor of red LEDs is the highest, 20%.

As shown in FIG. 6(C), as the display effect of area C is a high-brightness reddish hue, the pulse duty factors of the LEDs with various colors are greater than 50%, and the pulse duty factor of blue LEDs and the pulse duty factor of red LEDs are higher, 80% and 90% respectively.

Then, the LED driver IC 42 controls, based on the time sequence signals for various LEDs associated with respective backlight lamp group areas received from the time sequence control circuit 41, the brightness of individual LEDs of the multi-color LED light sources in the respective areas, so as to adjust the hue among the areas and the brightness of the current area. Finally, area A, area B and area C can display corresponding hues and brightness.

With regard to a structure with white LEDs as a backlight source in the prior art, the white LEDs can only achieve an NTSC (National Television System Committee) color gamut of 75.2%. In contrast, with regard to the above-mentioned structure of the example, the color gamut of the backlight source can achieve an NTSC color gamut of greater than 100% due to RGB LEDs.

In addition, the present disclosure further provides a liquid crystal display device, comprising the above-mentioned backlight source, and a liquid crystal display panel. The liquid crystal display panel performs image display according to the image data obtained, and moreover, the liquid crystal display panel is divided into a plurality of display picture regions.

In conclusion, according to the backlight source structure of the present disclosure, through dividing the backlight source so as to be in correspondence with different display picture regions of the liquid crystal display panel, and controlling the brightness of the LEDs with various colors, such as red LEDs, green LEDs and blue LEDs, of the multi-color LED light sources in different areas based on the display contents in the different display picture regions, the hue among the areas can be changed, and the expression of LCD pictures can be improved. Therefore, the color can be brighter, and the color gamut range can be expanded. Meanwhile, with the brightness of an area in which a white LED in the multi-color LED light source is located being compensated by controlling said white LEDs, the contrast can be improved.

The foregoing descriptions are merely preferred specific embodiments of the present disclosure, but the protection scope of the present disclosure is not limited thereto. Readily conceivable variations or substitutions, to any skilled one who is familiar with this art, within the disclosed technical scope of the present disclosure shall be incorporated in the protection scope of the present disclosure. Accordingly, the protection scope of the claims should be subjected to the protection scope of the present disclosure.

1. A backlight source for a liquid crystal display device, comprising:
a backlight lamp group, which is divided into at least two areas, each being provided with a group of multi-color LED light sources distributed therein, and the individual areas formed by dividing the backlight lamp group being in one-to-one correspondence with individual display picture regions formed by dividing a liquid crystal display panel of the liquid crystal display device;
a time sequence control circuit, which, based on the hue and brightness information of an image that should be displayed currently in the image data analyzed by different display picture regions of the liquid crystal display panel, generates time sequence signals for individual LEDs of a group of multi-color LED light sources in the backlight lamp group area associated with a respective region; and
an LED driving circuit, which is electrically connected between the time sequence control circuit and the backlight lamp group, and, based on the received time sequence signals for individual LEDs associated with different backlight lamp group areas respectively, controls the brightness of individual LEDs of the multi-color LED light sources in respective areas, so as to adjust the hue among the areas and the brightness of the current area.

2. The backlight source according to claim 1, wherein, when the backlight source is a side-light type backlight source, each multi-color LED light source includes a plurality of groups of LED lamp bars formed by providing red LEDs, green LEDs, blue LEDs and white LEDs distributed with a set sequence, each of the white LEDs being used for performing brightness compensation on the area where it is located.

3. The backlight source according to claim 1, wherein, when the backlight source is a direct type backlight source, each multi-color LED light source includes at least one group of annular lamp bead units fixated by providing red LEDs, green LEDs, blue LEDs and white LEDs distributed with a set sequence, each white LEDs being used for performing brightness compensation on the area where it is located.

4. The backlight source according to claim 1, wherein the time sequence control circuit comprises:
an image data obtaining device, used for obtaining image data of the liquid crystal display panel;
an image data partition calculating device, used for processing the image data obtained by the image data obtaining device, and, based on the pixel position of each image data in the current region of the liquid crystal display panel, calculating the average hue and brightness information in the current region; and
an LED time sequence signal generating module, used for, based on the average hue and brightness information in each region, generating time sequence signals for individual LEDs of a group of multi-color LED light sources in the backlight lamp group area associated with a respective region.

5. The backlight source according to claim 2, wherein the time sequence control circuit comprises:
an image data obtaining device, used for obtaining image data of the liquid crystal display panel;
an image data partition calculating device, used for processing the image data obtained by the image data obtaining device, and, based on the pixel position of each image data in the current region of the liquid crystal display panel, calculating the average hue and brightness information in the current region; and
an LED time sequence signal generating module, used for, based on the average hue and brightness information in each region, generating time sequence signals for individual LEDs of a group of multi-color LED light sources in the backlight lamp group area associated with a respective region.

6. The backlight source according to claim 3, wherein the time sequence control circuit comprises:
an image data obtaining device, used for obtaining image data of the liquid crystal display panel;
an image data partition calculating device, used for processing the image data obtained by the image data obtaining device, and, based on the pixel position of each image data in the current region of the liquid crystal display panel, calculating the average hue and brightness information in the current region; and
an LED time sequence signal generating module, used for, based on the average hue and brightness information in each region, generating time sequence signals for individual LEDs of a group of multi-color LED light sources in the backlight lamp group area associated with a respective region.

7. A liquid crystal display device, comprising:
a liquid crystal display panel, which performs image display based on image data obtained, and is divided into a plurality of display picture regions; and
a backlight source, comprising:
a backlight lamp group which is divided into at least two areas, each being provided with a group of multi-color LED light sources distributed therein, and the individual areas formed by dividing the backlight lamp group being in one-to-one correspondence with individual display picture regions formed by dividing a liquid crystal display panel;
a time sequence control circuit, which, based on the hue and brightness information of an image that should be displayed currently in the image data analyzed by different display picture regions of the liquid crystal display panel, generates time sequence signals for individual LEDs of a group of multi-color LED light sources in the backlight lamp group area associated with a respective region; and
an LED driving circuit, which is electrically connected between the time sequence control circuit and the backlight lamp group, and, based on the received time sequence signals for individual LEDs associated with different backlight lamp group areas respectively, controls the brightness of individual LEDs of the multi-color LED light sources in respective areas, so as to adjust the hue among the areas and the brightness of the current area.

8. The liquid crystal display device according to claim 7, wherein the time sequence control circuit comprises:
an image data obtaining device, used for obtaining image data of the liquid crystal display panel;
an image data partition calculating device, used for processing the image data obtained by the image data obtaining device, and, based on the pixel position of each image data in the current region of the liquid crystal display panel, calculating the average hue and brightness information in the current region; and
an LED time sequence signal generating module, used for, based on the average hue and brightness information in each region, generating time sequence signals for individual LEDs of a group of multi-color LED light sources in the backlight lamp group area associated with a respective region.

9. The liquid crystal display device according to claim 7, wherein the multi-color LED light source is one formed by providing multi-color LEDs, including white LEDs, distributed with a set sequence, wherein each white LED is used for performing brightness compensation on the area where it is located; and
the time sequence control circuit, based on the hue and brightness information of an image needing to be displayed currently in the image data analyzed by different display picture regions of the liquid crystal display panel, generates time sequence signals for individual LEDs other than white LEDS in each backlight lamp group area associated with a respective region, so as to perform hue matching on pictures in the corresponding areas, and generates time sequence signals of the white LEDs so as to perform brightness supplement.

10. The liquid crystal display device according to claim 8, wherein the multi-color LED light source is one formed by providing multi-color LEDs, including white LEDs, distributed with a set sequence, wherein each white LED is used for performing brightness compensation on the area where it is located; and
the time sequence control circuit, based on the hue and brightness information of an image needing to be displayed currently in the image data analyzed by different display picture regions of the liquid crystal display panel, generates time sequence signals for individual LEDs other than white LEDS in each backlight lamp group area associated with a respective region, so as to perform hue matching on pictures in the corresponding areas, and generates time sequence signals of the white LEDs so as to perform brightness supplement.

11. The liquid crystal display device according to claim 7, when the backlight source is a direct type backlight source, each multi-color LED light source includes at least one group of annular lamp bead units formed by distributing red LEDs, green LEDs, blue LEDs and white LEDs according to a set sequence, wherein each white LEDs is used for performing brightness compensation on the area where it is located.

12. A dimming method for a liquid crystal display device, comprising steps of:
dividing a backlight lamp group of a backlight source into at least two areas, each being provided with multi-color LED light sources distributed therein, and the individual areas formed by dividing the backlight lamp group being in one-to-one correspondence with individual display picture regions formed by dividing a liquid crystal display panel;
obtaining image data, through a time sequence control circuit, from the liquid crystal display panel, and, based on the hue and brightness information of an image needing to be displayed currently in the analyzed by different display picture regions of the liquid crystal display panel, generates time sequence signals for individual LEDs of a group of multi-color LED light sources in each backlight lamp group area associated with a respective region; and
based on the received time sequence signals for individual LEDs associated with different backlight lamp group areas respectively, controlling, through an LED driving circuit, the brightness of individual LEDs of the multi-color LED light sources in respective areas, so as to adjust the hue of the areas and the brightness of the current area.

13. The dimming method according to claim 12, wherein the multi-color LED light source is one formed by providing multi-color LEDs, including white LEDs, distributed with a set sequence, wherein each white LED is used for performing brightness compensation on the area where it is located; and
the time sequence control circuit, based on the hue and brightness information of an image needing to be displayed currently in the image data analyzed by different display picture regions of the liquid crystal display panel, generates time sequence signals for individual LEDs other than white LEDS in each backlight lamp group area associated with a respective region, so as to perform hue matching on pictures in the corresponding areas, and generates time sequence signals of the white LEDs so as to perform brightness supplement.
